(19) United States
(12) Patent Application Publication
(10) Pub. No.: US 2015/0178301 A1
(43) Pub. Date: Jun. 25, 2015

(54) SYSTEMS AND METHODS TO GENERATE A SEARCH QUERY

(71) Applicant: EBAY INC., SAN JOSE, CA (US)

(72) Inventors: Venkateswaran Subramanian Karthik, Santa Clara, CA (US); Shrish Mishra, Mountain View, CA (US); Dalvinder Singh, Santa Clara, CA (US); Manas Haribhai Somaiya, Sunnyvale, CA (US)

(73) Assignee: EBAY INC., SAN JOSE, CA (US)

(21) Appl. No.: 14/137,543

(22) Filed: Dec. 20, 2013

(51) Int. Cl. G06F 17/30

(52) U.S. Cl. CPC G06F 17/3097

(57) ABSTRACT

A description of an abstraction of items may be received as an input from a device operated by a user. The abstraction of the items may represent a group of items. Item descriptors may be accessed from a database based on the description of the abstraction of the group of items. Moreover, the item descriptors may describe the items included in the abstraction of the items. After being accessed from the database, the item descriptors may be used in generating a search query. Lastly, the generated search query may be presented to the device operated by the user.

### TECHNICAL FIELD

This application relates generally to data processing, and more specifically to systems and methods to generate a search query.

### BACKGROUND

A user may search for one or more items. The one or more items may be listed as item pages to be viewed online. In order to retrieve the item pages of each of the one or more items, the user may submit individual search queries for each of the one or more items.

### BRIEF DESCRIPTION OF THE DRAWINGS

Some embodiments are illustrated by way of example and not limitation in the figures of the accompanying drawings in which:

FIG. 1 is a network diagram illustrating a network environment suitable for generating a search query, according to an example embodiment;

FIG. 2 is a block diagram illustrating an abstraction machine, according to an example embodiment;

FIG. 3 is a user interface, according to an example embodiment, to receive input from a user;

FIG. 4 is a user interface, according to an example embodiment, to receive input from a user, the input including a recipient identifier;

FIG. 5 is a user interface of an item page, according to an example embodiment;

FIG. 6 is a user interface, according to an example embodiment, to receive input from a user;

FIG. 7 is a user interface, according to an example embodiment, to receive input from a user;

FIG. 8 depicts a method of presenting a generated search query, according to an example embodiment; and

FIG. 9 is a diagrammatic representation of a machine in the example form of a computer system within which a set of instructions for causing the machine to perform any one or more of the methodologies discussed herein may be executed.

### DETAILED DESCRIPTION

A user may provide an input to browse for items online. In some instances, the user would like to search a group of items. Instead of providing a search query for each of the individual items among the group of items, the user may provide an input that includes a description of an abstraction of the group of items. An abstraction machine may then utilize the description of the abstraction of the group of items to access item descriptors and generate a search query based on the item descriptors.

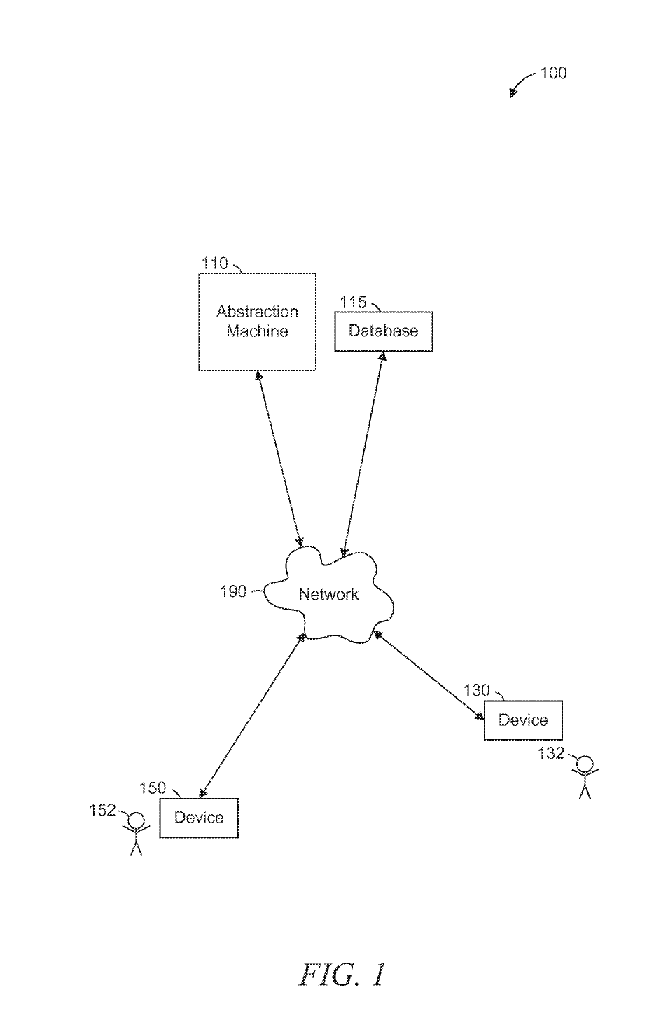

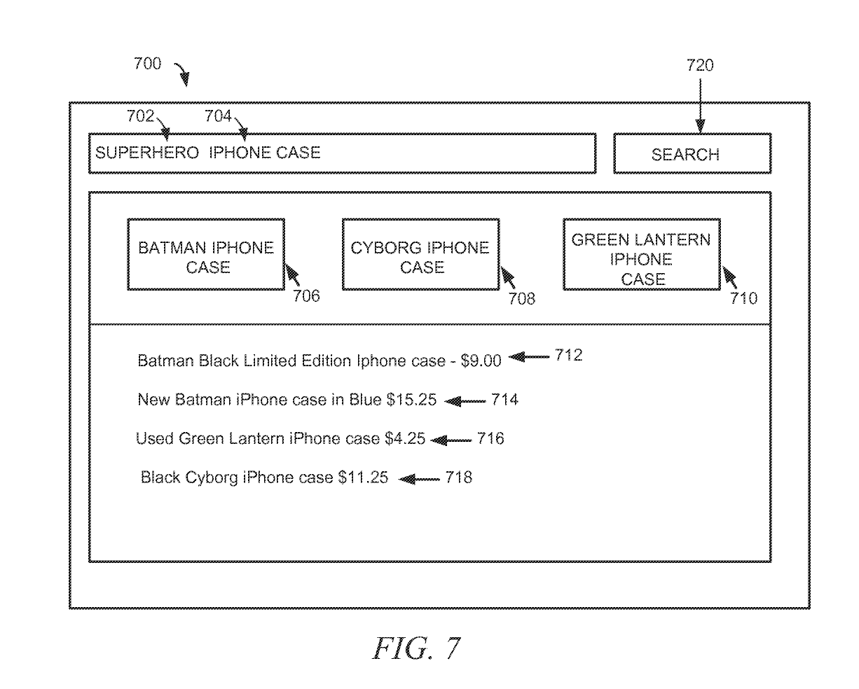

FIG. 1 is a network diagram illustrating a network environment 100 suitable for generating a search query, according to an example embodiment. The network environment 100 may include an abstraction machine 110, a database 115, and devices 130, and 150 that are communicatively coupled to each other via a network 190. The abstraction machine 110 and the devices 130, and 150 may each be implemented in a computer system, in whole or in part, as described below with respect to FIG. 7. In various example embodiments, the abstraction machine 110 may be used to generate a search query in response to receiving a description of an abstraction of items, as further explained below.

Also shown in FIG. 1 are users 132 and 152 who may be human (e.g., a human being), a machine (e.g., a computer configured by a software program to interact with the device 130), or any suitable combination thereof (e.g., a human assisted by a machine or a machine supervised by a human). The user 132 is not part of the network environment 100, but is associated with the device 130 and may be a user of the device 130. For example, the device 130 may be a desktop computer, a vehicle computer, a tablet computer, a navigational device, a portable media device, or a smart phone belonging to the user 132. Likewise, the user 152 is not part of the network environment 100, but is associated with the device 150. For example, the device 150 may be a desktop computer, a vehicle computer, a tablet computer, a navigational device, a portable media device, or a smart phone that is operated by the user 152.

Broadly, the user (e.g., user 132, user 152) may provide a description of an abstraction of items via a device (e.g., device 130, device 150) to the abstraction machine 110. In response, the abstraction machine 110 may access item descriptors based on the description of the abstraction of items. Further, the abstraction machine 110 may generate a search query based on the item descriptors and present the generated search query to the device (e.g., device 130, device 150).

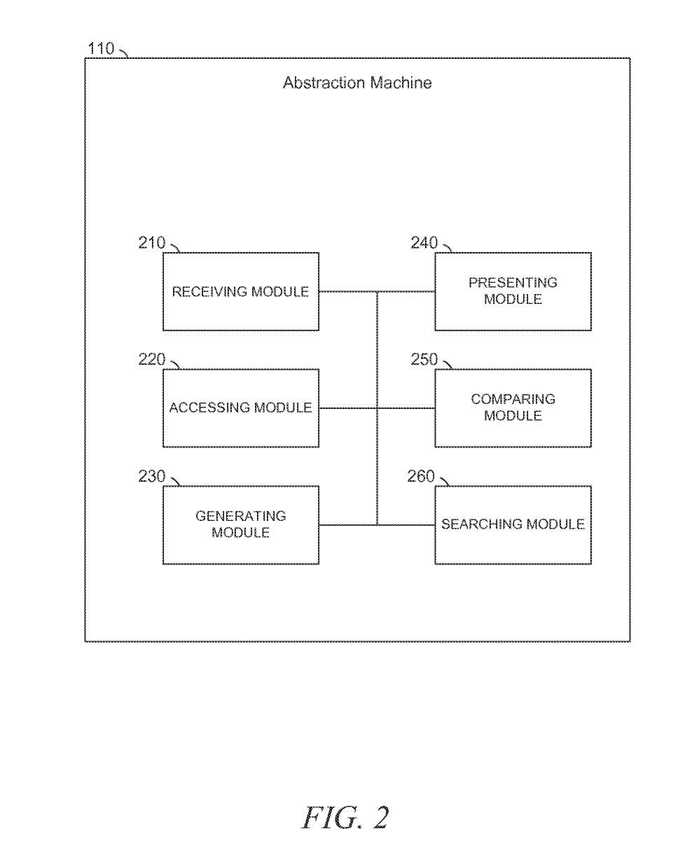

FIG. 2 is a block diagram illustrating an abstraction machine 110, according to an example embodiment. The abstraction machine 110 may include a receiving module 210, an accessing module 220, a generating module 230, a presenting module 240, a comparing module 250, and a searching module 260, all configured to communicate with each other (e.g., via a bus, shared memory, or a switch).

In various embodiments, the receiving module 210 may receive an input that includes a description of an abstraction of items (e.g., category, color, purpose, or context). The input may be received from a device (e.g., device 130) operated by a user (e.g., user 132). The abstraction of the items may represent a group of items. As such, each item among the group may be included in the abstraction of the items. For instance, the description of the abstraction of the items may describe items belonging to a category, items used in a specific context, items sharing an attribute, items used in a specific situation, items that serve a specific purpose, and the like. In various embodiments, the receiving module 210 is further configured to receive an indication of the input as being a description of an abstraction of items. For instance, a hashtag may be used to indicate that the input is being used as the description of the abstraction of items. In various embodiments, the receiving module 210 may be further configured to receive an identification of a further user (e.g., user 152), or a recipient, from the device (e.g., device 130) operated by the user (e.g., user 132). The user may be shopping for items that the user (e.g., user 132) would like to buy for the recipient (e.g., user 152). The identification of the recipient may include a name, a unique identifier of an account belonging to the recipient, and the like. The identification of the recipient may be used by the accessing module 220 to access item preferences of the recipient, as explained in further detail below.

In various embodiments, the receiving module 210 is further configured to receive an indication of an item as being included in the abstraction of the items. The receiving module 210 may receive the indication prior to receiving the description of the abstraction of the items from the device (e.g., device 130) operated by the user (e.g., user 132). In response to receiving the description of the abstraction of items, the accessing module 220 may be further configured to access item descriptors of the item based on the receiving the indication of the item as being included in the abstraction of the items. In various embodiments, the receiving module 210 may receive the indication of the item as being included in the abstraction of the items from a further user (e.g., user 152).

In various embodiments, the accessing module 220 may access item descriptors from a database based on the abstraction of the items described in the input received at the receiving module 210. The item descriptors may respectively describe the items that are included in the abstraction of items. For instance, the abstraction of items may be a category of items and the item descriptors may respectively describe the items belonging to the category. As another example, the abstraction of items may be items used in a specific context. The item descriptors may respectively describe the items used in the specific context. Moreover, the abstraction of items may be items sharing an attribute. As such, the item descriptors may respectively describe the items sharing the attribute. In various example embodiments, an abstraction of items such as “superhero” may be used to describe a category of items. Item descriptors that correspond to the “superhero” abstraction of items may include Batman, Superman, X-men, and the like. As another example, an abstraction of items such as “outdoor” may be used to describe a specific context in which items are being used. Item descriptors corresponding to the “outdoor” abstraction of items may include: waterproof, resistant, durable, and the like. The item descriptors may also include item characteristics (e.g., an item color, an item attribute, an item type, an item price, and the like) of the items that are included in the abstraction of items. Moreover, the item descriptors may be used to distinguish the items included in the abstraction of items from one another. In various embodiments, each item included in the abstraction of the items may be associated with an item page which may be viewed online by a device that is associated with the user. The item page may include a title of the item, a description of the item, an image of the item, and the like. In various embodiments, the item descriptors accessed from the database may also be present in the item pages of the items that are included in the abstraction of the items. In various embodiments, the access module 220 may be further configured to access descriptions that may be used as an abstraction of items in response to the receiving module 210 receiving an indication of the input as being a description of an abstraction of items. For instance, if the description of the abstraction of items is “NBA”, the access module 220 may retrieve suggested descriptions which may also be used as an abstraction of items, such as “NFL” or “NHL”. In various embodiments, the access module 220 may retrieve suggested descriptions “NFL” and “NHL” in response to the receiving module 210 receiving a portion of a description of an abstraction of items, such as

In various embodiments, the database accessed by the accessing module 220 may be indexed according to the abstraction of the items. The accessing module 220 may access the database by referencing the indexed portion of the database that corresponds to the abstraction of the items described by the input received at the receiving module 210. For instance, item descriptors for Batman, Superman, and X-men may be stored in a section of the database corresponding to the “superhero” abstraction of items (e.g., retrievable from the database via a hashing function that maps the item descriptors to the description of the abstraction of items). Whereas item descriptors for waterproof, resistant, and durable may be stored in a section of the database corresponding to the “outdoor” abstraction of items.

In various embodiments, the item descriptors accessed from the database may be absent from the input that includes the description of the abstraction of the items received at the receiving module 210. For example, the item characteristics of the items included in the abstraction of the items may be absent from the input received at the receiving module 210. As such, the item descriptors accessed from the database by the accessing module 220 may describe the items at a more specific level as compared to the abstraction of the items described by the input. In various embodiments, the accessing module 220 may be further configured to access item preferences of the user. Moreover, the accessing module 220 may be further configured to access item preferences of the recipient based on a recipient identifier received at the receiving module 210, as described above. The item preferences may indicate a preference for a specific brand of item, price of item, color of item, popularity of item, and the like.

In various embodiments, the generating module 230 may be configured to generate a search query based on the item descriptors accessed from the database. In various embodiments, the generating module 230 may add the item descriptors to the search query. As stated previously, the item descriptors may respectively describe the items included in the abstraction of the items. For instance, the item descriptors may be the item characteristics of the items included in the abstraction of the items. In various embodiments, the generating module 230 may be further configured to generate the search query based on a determined subset of item descriptors, as further explained below. The generating module 230 may remove item descriptors not included in the subset of item descriptors, thereby retaining the item descriptors included in the subset of item descriptors.

In various embodiments, the presenting module 240 may be configured to present the generated search query to the device operated by the user. The presenting module 240 may be further configured to present the item descriptors added to the search query by the generating module 230. In various embodiments, the presenting module 240 may be further configured to present the generated search query to the device operated by the user prior to the receiving an indication to perform a search. The indication to perform the search may be received at the receiving module 210 from the device operated by the user.

In various embodiments, the receiving module 210 may further be configured to receive an indication from the device operated by the user to perform the search. In various embodiments, the searching module 260 may perform the search based on the search query generated by the generating module 230. In various embodiments, the search performed by the searching module 260 may retrieve the item pages of the items included in the abstraction of the items.

In various embodiments, the accessing module 220 may be further configured to determine a subset of the item descriptors based on the item preferences of the user. In response, the generating module 230 may be further configured to generate the search query based on the determined subset of the item descriptors corresponding to the item preferences of the user. The generating module 230 may be further configured to remove, from the search query, item descriptors not included in the subset of item descriptors, thereby retaining the item descriptors included in the subset of item descriptors. As a result, the presentation module 240 may be further configured to present the search query generated based on the subset of item descriptors to the device operated by the user. In various embodiments, the accessing module 220 may be further configured to determine a further subset of the item descriptors based on the item preferences of the recipient. In response, the generating module 230 may further be configured to generate the search query based on the further subset of the item descriptors corresponding to the item preferences of the recipient. The generating module 230 may remove, from the search query, item descriptors not included in the further subset of item descriptors, thereby retaining the item descriptors included in the further subset of item descriptors. The presentation module 240 may then be further configured to present the generated search query based on the further subset of item descriptors to the device operated by the user.

In various embodiments, the comparing module 250 may Be configured to measure an amount of overlap between the item preferences of the user and the further user. The accessing module 220 may be further configured to access the item preferences of the further user, or the contributor. The amount of overlap may be measured based on a number of common preferences between the user and the contributor with respect to the specific brand of item, the price of item, the color of item, the popularity of item, and the like. The comparison module 250 may determine the user and the contributor as having similar item preferences based on the amount of overlap between the item preferences of the user and the contributor. In various instances, the comparison module 250 may determine the amount of overlap as exceeding a predetermined threshold.

Any one or more of the modules described herein may be implemented using hardware (e.g., a processor of a machine) or a combination of hardware and software. For example, any module described herein may configure a processor to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

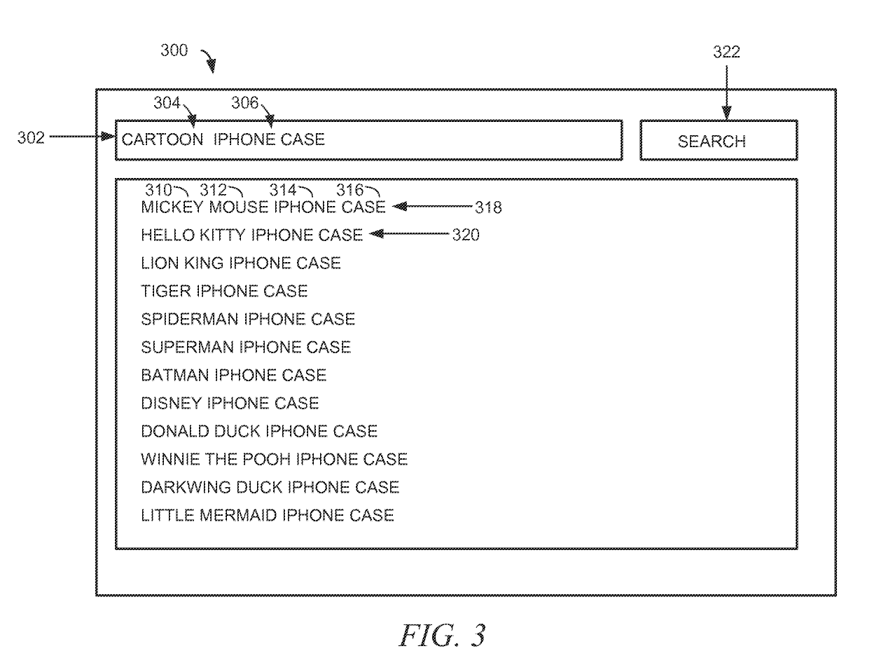

FIG. 3 is a user interface 300, according to an example embodiment, to receive input from a user. The user interface 300 may receive, via the search bar 302, a description of an abstraction of items from the user. For instance, in the example user interface 300, an abstraction of the items may be the term “Cartoon” 304. The remaining terms “iPhone case” 306 may also be identified as an abstraction of items. The accessing module 220 may access item descriptors based on the abstraction of the items “Cartoon” 304 and the abstraction of items “iPhone case” 306. Moreover, the generating module 230 may generate a search query based on the item descriptors accessed from the database (e.g., database 115) by the accessing module 220. For instance, as depicted in the example user interface 300, the item descriptors “Mickey Mouse iPhone case” may be used to generate search query 318 as a result of being included in the abstraction of items “Cartoon” 304 and the abstraction of items “iPhone case” 306. Therefore, each of the terms “Mickey” 310, “Mouse” 312, “iPhone” 314, and “case” 316 may all be item descriptors that correspond to the abstraction of items “Cartoon” 304 and the abstraction of items “iPhone case” 306. For instance, the terms “Mickey” 310 and “Mouse” 312 may be included in the abstraction of items “Cartoon” 304 and the terms “iPhone” 314 and “case” 316 may be included in the abstraction of items “iPhone case” 306. Moreover, the terms “Mickey” 310, “Mouse” 312, “iPhone” 314, and “case” 316 may all be added to search query 318.

More than one search query may be generated by the generating module 230, according to an embodiment. As such, the item descriptors “Hello Kitty iPhone case” may be used to generate a further search query 320 as a result of being part of the abstraction of items “Cartoon” 304 and “iPhone case” 306. In various embodiments, the search query may be presented by the presenting module 240 to the user prior to the user submitting the search query by clicking on search button 322. Moreover, each of the generated search queries (e.g., search query 318 and search query 320) may be selectable by the user to perform a search.

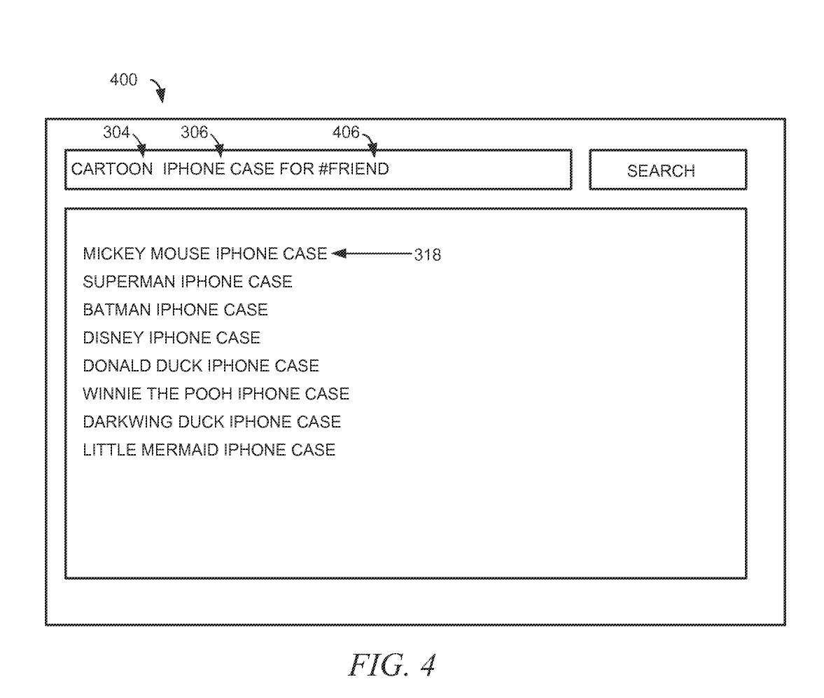

FIG. 4 is a user interface 400, according to an example embodiment, to receive input from a user, the input including a recipient identifier. The input may be received in a search bar and may further include a recipient identifier 406 (e.g., “#Friend”). The input may also include the description of an abstraction of items “Cartoon” 304 and “iPhone case” 306 from FIG. 3. The accessing module 220 (shown in FIG. 2) may access item preferences of the recipient based on the recipient identifier received at the receiving module 210 (shown in FIG, 2). Moreover, the accessing module 220 may determine a subset of the item descriptors based on the item preferences of the recipient identified by the recipient identifier 406. The generating module 230 may generate the search query 318 of FIG. 3 displayed in the example user interface 400 based on the subset of the item descriptors determined based on the item preferences of the recipient. Moreover, some of the search queries present in FIG. 3 may no longer be present in FIG. 4. For instance, the recipient may not have a preference for Hello Kitty, and therefore, the item descriptors “Hello Kitty iPhone case” may be removed, leaving the search query 320 of FIG. 3 absent from FIG. 4. Therefore, the generated search queries displayed in FIG. 4 are generated based on the subset of item descriptors that correspond to the item preferences of the recipient.

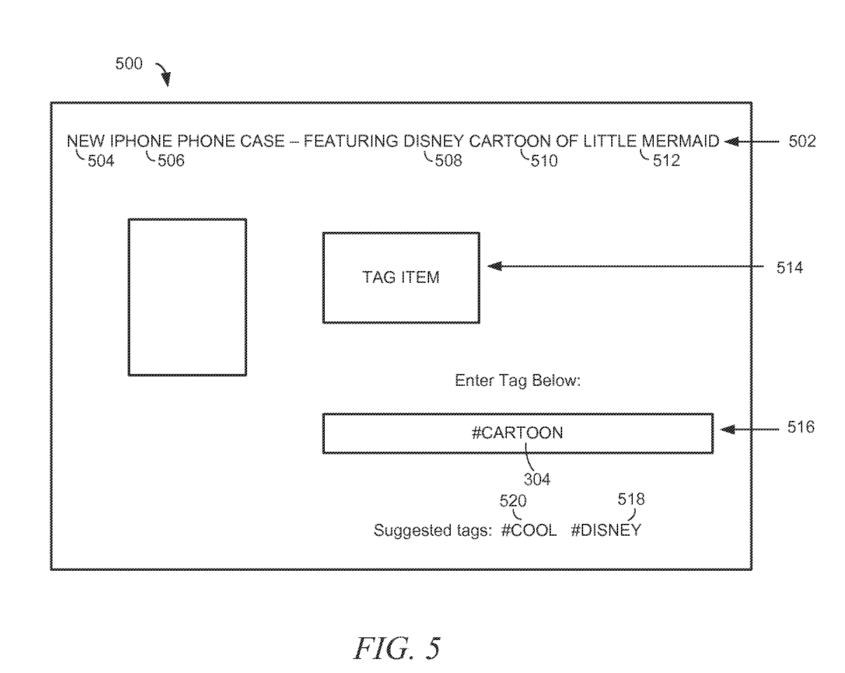

FIG. 5 is a user interface of an item page 500, according to an example embodiment. The item page may be used to associate a description of the abstraction of items 304 to item descriptors. The item page 500 may include an item in the form of an iPhone case featuring the Little Mermaid, as illustrated in the title 502 of the item page 500. The title 502 of the item page 500 may further include item descriptors that describe the item, such as “New” 504, “iPhone” 506, “Disney” 508, “Cartoon” 510, and “Little Mermaid” 512. The item descriptors may be received from a contributor (e.g., user 132, user 152). The item descriptors that describe the item may also be stored in a database (e.g., database 115). The contributor (e.g., user 132, 152) may provide a description of an abstraction of items 304 that is received at the input bar 516. For instance, the description of the abstraction of items 304 may be “Cartoon.” Upon selection of control 514, the receiving module 210 may receive an indication that the iPhone case featuring the Little Mermaid be included in the abstraction of items described as “Cartoon” provided at the input bar 516. As a result, responsive to a user (e.g., user 132, user 152) providing “Cartoon” as the description of the abstraction of items 304, the item descriptors included in the item page 500 may be used in generating a search query. Moreover, the generating module 230 (shown in FIG, 2) may use the item descriptors included in the item page 500 in response to the comparing module 250 (shown in FIG. 2) determining that the user and the contributor as having similar item preferences based on the amount of overlap between the item preferences of the user and the contributor. In various example embodiments, the example user interface of the item page 500 may also include suggested tags, such as “Cool” 520 and “Disney” 518. The suggested tags may be used to include the item in an abstraction of items described as “Cool” 520 or an abstraction of items described as “Disney” 518. As a result, responsive to a user providing “Cool” or “Disney” as the description of the abstraction of items, the item descriptors included in the item page 500 may be used in generating a search query.

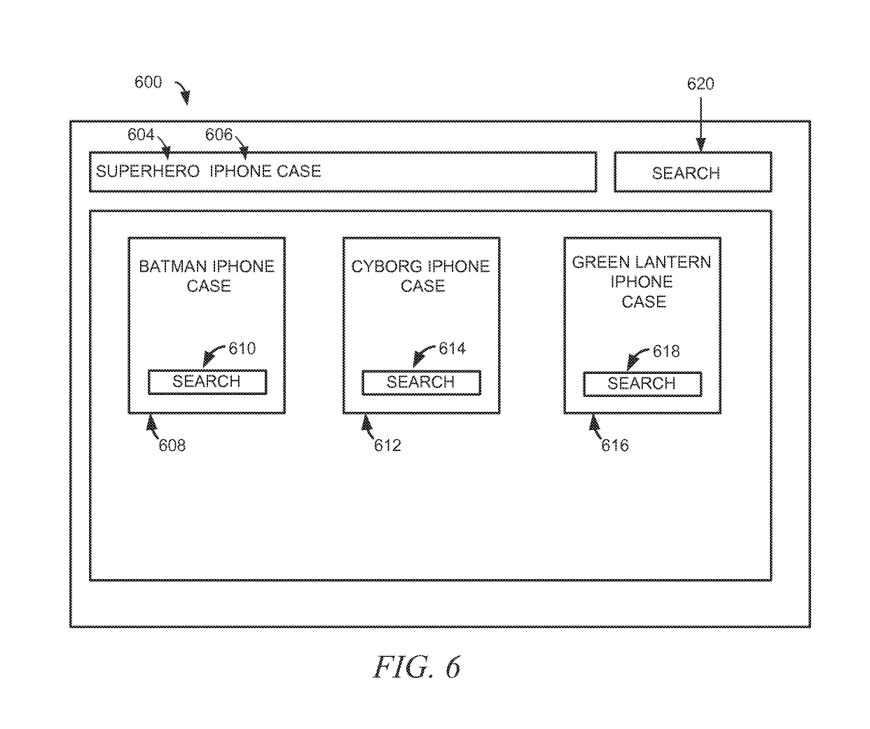

FIG. 6 is a user interface 600, according to an example embodiment, to receive input from a user. The user interface 600 may receive, via a search bar, a description of an abstraction of items from the user. For instance, in the example user interface 600, an abstraction of items may be the terms “Superhero” 604, and “iPhone case” 606. Each of the terms may be an abstraction of items that are usable to retrieve item descriptors. In various example embodiments, the user interface 600 includes a search button 620 operable to perform a search using the description of the abstraction of items included in the search bar. Upon operation of the search button 620, search results may be generated by the generating module 230. The search results may include the item descriptors being placed into separate categories. For example, a first category 608 may include item descriptors for “Batman iPhone case,” which correspond to the “Superhero” 605 abstraction of items and the “iPhone case” 606 abstraction of items. The first category 608 may include images that are described by the item descriptors for “Batman iPhone case.” For instance, the first category 608 may include images of iPhone cases which feature Batman on at least a portion of the product. Moreover, the first category 608 may further include a search button 610 operable to perform a further search on items pages that correspond to the item descriptors for “Batman iPhone case.” For instance, the item pages that correspond to the item descriptors for “Batman iPhone case” may be item pages that include any of the item descriptors “Batman,” “iPhone,” and “case” somewhere in their descriptions. Likewise, the second category 612 may include item descriptors for “Cyborg iPhone case” which correspond to the “Superhero” 604 abstraction of items and the “iPhone case” 606 abstraction of items. Moreover, the second category 612 may further include a search button 610 operable to perform a further search on items pages that correspond to the item descriptors for “Cyborg iPhone case.” For instance, the item pages that correspond to the item descriptors for “Cyborg iPhone case” may be item pages that include any of the item descriptors “Cyborg,” “iPhone,” and “case” somewhere in their descriptions. Likewise, the third category 616 may include item descriptors for “Green Lantern iPhone case” which correspond to the “Superhero” 604 abstraction of items and the “iPhone case” 606 abstraction of items. Moreover, the third category 616 may further include a search button 610 operable to perform a further search on items pages that correspond to the item descriptors for “Green Lantern iPhone case.” For instance, the item pages that correspond to the item descriptors for “Green Lantern iPhone case” may be item pages that include any of the item descriptors “Green Lantern,” “iPhone,” and “case” somewhere in their descriptions.

FIG. 7 is a user interface 700, according to an example embodiment, to receive input from a user. The user interface 700 may receive, via a search bar, a description of an abstraction of items from the user. For instance, in the example user interface 600, an abstraction of items may be the terms “Superhero” 604, and “iPhone case” 606. In various example embodiments, the user interface 700 includes a search button 720 operable to perform a search using the description of the abstraction of items included in the search bar. Upon operation of the search button 720, search results may be generated by the generating module 230. The search results may include descriptions of items that are included in the abstraction of items. Moreover, the search results may further include item descriptors being used as filters to filter the descriptions of the items that are included in the abstraction of items. A first filter 706, a second filter 708, and a third filter 710 may be displayed in the user interface 700. Each filter may be selectable to narrow the description of the items that are included in the abstraction of items. For example, upon selecting the first filter 706 for “Batman iPhone case”, the generation module 230 may cause descriptions 712 and 714 to remain and further remove descriptions 716 and 718 from the user interface 700. Likewise, upon selecting the second filter 708 for “Cyborg iPhone case”, the generation module 230 may cause the description 718 to remain and further remove the descriptions 712, 714, and 716 from the user interface 700. Lastly, upon selecting the third filter 710 for “Green Lantern iPhone case”, the generation module 230 may cause the description 716 to remain and further remove the descriptions, 712, 714, and 718 from the user interface 700. In various example embodiments, the descriptions 712, 714, 716, and 718 may be present in the item pages of the items that are included in the abstraction of items. Moreover, the item descriptors may include terms that are included in the descriptions 712, 714, 716, and 718. Moreover, each of the descriptions 712, 714, 716, and 718 may be selectable as a link to an item page.

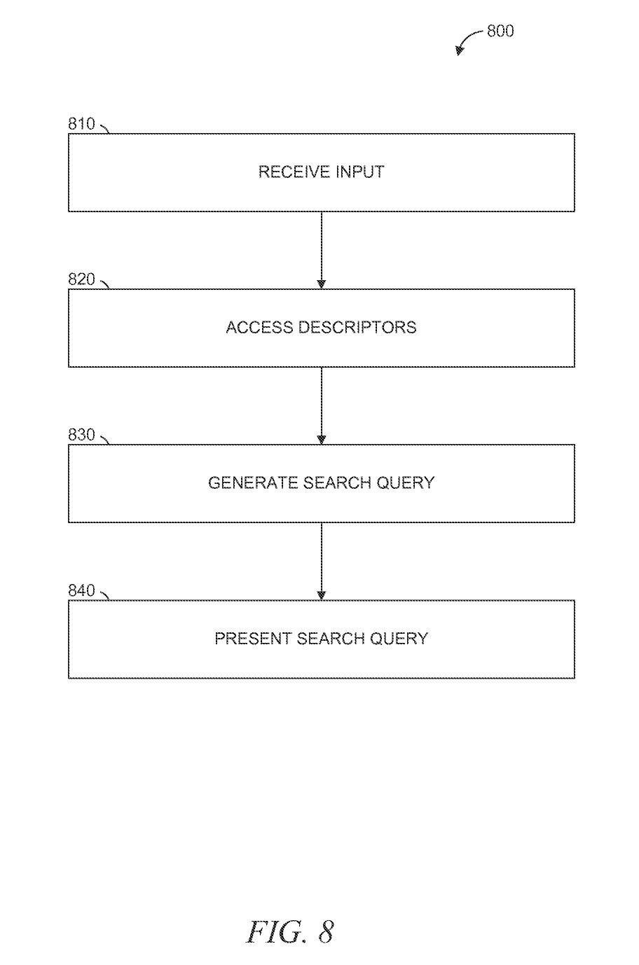

FIG. 8 depicts a method of presenting a generated search query, according to an example embodiment. At step 810, the receiving module 210 may receive an input including a description of an abstraction of items (e.g., element 304 of FIG. 3). In various embodiments, the abstraction of the items may represent a group of items. As such, each item among the group of items may be included in the abstraction of the items. For instance, the description of the abstraction of the items may describe items belonging to a category, items used in a specific context, items sharing an attribute, items used in a specific situation, items that serve a specific purpose, and the like.

At step 820, the accessing module 220 may access item descriptors from a database based on the abstraction of the items described in the input received at the receiving module 210. The item descriptors may respectively describe the items that are included in the abstraction of items. In various embodiments, the item descriptors may be item characteristics (e.g., an item color, an item attribute, an item type, an item price, and the like). Moreover, item descriptors for each of the items may be used to distinguish each of the items from one another.

At step 830, the generating module 230 may generate a search query based on the item descriptors accessed from the database. In various embodiments, the generating module 230 may generate the search query by adding the item descriptors accessed from the database to the search query.

At step 840, the presenting module 240 may present the generated search query to the device operated by the user. In various embodiments, the presenting module 240 may present the generated search query prior to an indication being received at the receiving module 210. The indication may be to perform a search and may be received from the device operated by the user.

Any of the machines, databases, or devices shown in FIG. 1 may be implemented in a general-purpose computer modified (e.g., configured or programmed) by software to be a special-purpose computer to perform one or more of the functions described herein for that machine, database, or device. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 190 may be any network that enables communication between or among machines, databases, and devices (e.g., the server machine 110 and the device 130). Accordingly, the network. 190 may be a wired network, a wireless network (e.g., a mobile or cellular network), or any suitable combination thereof. The network 190 may include one or more portions that constitute a private network, a public network (e,g., the Internet), or any suitable combination thereof. Accordingly, the network 190 may include one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., WiFi network or WiMax network), or any suitable combination thereof. Any one or more portions of the network 190 may communicate information via a transmission medium. As used herein, “transmission medium” shall be taken to include any intangible medium that is capable of storing, encoding, or carrying instructions for execution by a machine, and includes digital or analog communication signals or other intangible media to facilitate communication of such software.

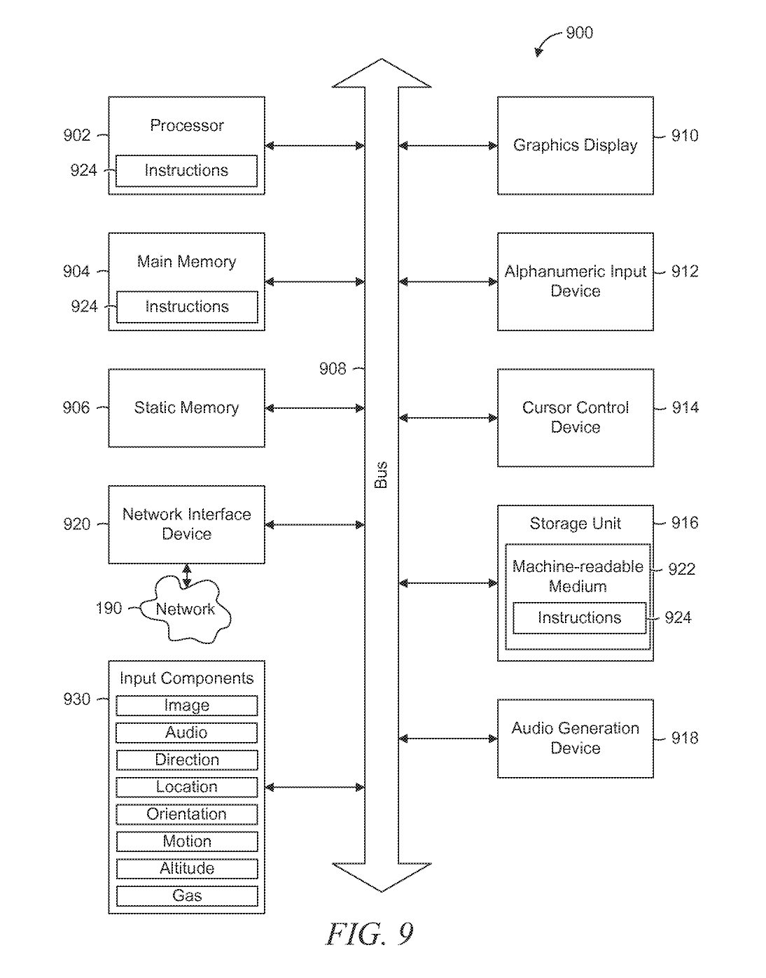

FIG. 9 is a block diagram illustrating components of a machine 900, according to some example embodiments, able to read instructions 924 from a machine-readable medium 922 (e.g., a machine-readable storage medium, a computer-readable storage medium, or any suitable combination thereof) and perform any one or more of the methodologies discussed herein, in whole or in part. Specifically, FIG, 9 shows the machine 900 in the example form of a computer system within which the instructions 924 (e.g., software, a program, an application, an applet, an app, or other executable code) for causing the machine 900 to perform any one or more of the methodologies discussed herein may be executed, in whole or in part. In alternative embodiments, the machine 900 operates as a standalone device or may be connected (e.g., networked) to other machines. In a networked deployment, the machine 900 may operate in the capacity of a server machine or a client machine in a server-client network environment, or as a peer machine in a distributed (e.g., peer-to-peer) network environment. The machine 900 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 924, sequentially or otherwise, that specify actions to be taken by that machine. Further, while only a single machine is illustrated, the term “machine” shall also be taken to include any collection of machines that individually or jointly execute the instructions 924 to perform all or part of any one or more of the methodologies discussed herein.

The machine 900 includes a processor 902 (e.g., a central processing unit (CPU), a graphics processing unit (GPU), a digital signal processor (DSP), an application specific integrated circuit (ASIC), a radio-frequency integrated, circuit (RFIC), or any suitable combination thereof), a main memory 904, and a static memory 906, which are configured to communicate with each other via a bus 908. The processor 902 may contain microcircuits that are configurable, temporarily or permanently, by some or all of the instructions 924 such that the processor 902 is configurable to perform any one or more of the methodologies described herein, in whole or in part. For example, a set of one or more microcircuits of the processor 902 may be configurable to execute one or more modules (e.g., software modules) described herein.

The machine 900 may further include a graphics display 910 (e.g., a plasma display panel (PDP), a light emitting diode (LED) display, a liquid crystal display (LCD), a projector, a cathode ray tube (CRT), or any other display capable of displaying graphics or video). The machine 900 may also include an alphanumeric input device 912 (e,g., a keyboard or keypad), a cursor control device 914 (e.g., a mouse, a touchpad, a trackball, a joystick, a motion sensor, an eye tracking device, or other pointing instrument), a storage unit 916, an audio generation device 918 (e.g., a sound card, an amplifier, a speaker, a headphone jack, or any suitable combination thereof), and a network interface device 920.

The storage unit 916 includes the machine-readable medium 922 (e.g., a tangible and non-transitory machine-readable storage medium) on which are stored the instructions 924 embodying any one or more of the methodologies or functions described herein. The instructions 924 may also reside, completely or at least partially, within the main memory 904, within the processor 902 (e.g., within the processor's cache memory), or both, before or during execution thereof by the machine 900. Accordingly, the main memory 904 and the processor 902 may be considered machine-readable media (e.g., tangible and non-transitory machine-readable media). The instructions 92.4 may be transmitted or received over the network 190 via the network interface device 920. For example, the network interface device 920 may communicate the instructions 924 using any one or more transfer protocols (e.g., hypertext transfer protocol (HTTP)).

In some example embodiments, the machine 900 may be a portable computing device, such as a smart phone or tablet computer, and have one or more additional input components 930 (e.g., sensors or gauges). Examples of such input components 930 include an image input component (e.g., one or more cameras), an audio input component (e.g., a. microphone), a direction input component (e.g., compass), a location input component (e.g., a global positioning system ((GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 922 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 924 for execution by the machine 900, such that the instructions 924, when executed by one or more processors of the machine 900 (e.g., processor 902), cause the machine 900 to perform any one or more of the methodologies described herein, in whole or in part Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A. “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e,g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS), For example, at least some of the operations may be performed by a group of computers (as examples of machines including processors), with these operations being accessible via a network (e.g., the Internet) and via one or more appropriate interfaces (e.g., an application program interface (API)).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

1. A method comprising:
receiving input including a description of an abstraction of items, the input being received from a device operated by a user;
accessing item descriptors from a database based on the description of the abstraction of the items, the item descriptors describing items that are included in the abstraction of the items;
generating a search query based on the item descriptors, the generating being performed by a processor of a computer system; and
presenting the generated search query to the device operated by the user, the presenting done prior to receiving an indication from the device operated by the user to perform a search.

2. The method of claim 1, further comprising:
accessing item preferences of the user; and
determining a subset of the item descriptors based on the item preferences of the user, wherein the generating the search query is based on the determined subset of the item descriptors.

3. The method of claim 1, wherein the description of the abstraction of the items describes at least one of items belonging to a category, items used in a specific context, items sharing an attribute, a items used in a specific situation, and items that serve a specific purpose.

4. The method of claim 1, wherein the generating the search query based on the item descriptors includes adding the item descriptors to the search query, and wherein the presenting the generated search query to the device operated by the user includes presenting the item descriptors added to the search query.

5. The method of claim 1 further comprising:
receiving the indication from the device operated by the user to perform the search, the method further comprising:
performing a search based on the search query generated based on the item descriptors accessed from the database.

6. The method of claim 5, wherein the performing the search based on the search query includes retrieving item pages of the items included in the abstraction of the items.

7. The method of claim 1, further comprising:
receiving an identification of a second user;
accessing item preferences of the second user based on the received identification of the second user; and
determining a further subset of the item descriptors based on the item preferences of the second user, wherein the generating the search query is based on the determined further subset of the item descriptors.

8. The method of claim 1, further comprising:
receiving an indication of a further item as being included in the abstraction of the items prior to receiving the input that describes the abstraction of the items from the first user, and wherein the accessing the item descriptors includes accessing item descriptors of the further item based on receiving the indication of the further item as being included in the abstraction of the items.

9. The method of claim 8, further comprising:
receiving an identification of a second user;
accessing item preferences of the second user based on the received identification of the second user;
measuring an amount of overlap between the item preferences of the first user and the second user; and
determining the amount of overlap between the item preferences of the first user and the second user as exceeding a predetermined threshold amount, and wherein the indication of the further item as being included in the abstraction of items is received from the second user.

10. The method of claim 1, wherein the item descriptors are absent from the description of the abstraction of the items.

11. A system comprising:
a receiving module configured to receive an input including a description of an abstraction of items, the input being received from a device operated by a user;
an accessing module configured to access item descriptors from a database based on the description of the abstraction of the items, the item descriptors describing items that are included in the abstraction of the items;
a generating module configured to generate a search query based on the item descriptors; and
a presenting module configured to present the generated search query to the device operated by the user, the presenting module to present the generated search query prior to an indication being received at the receiving module, the indication to perform a search and being received from the device operated by the user.

12. The system of claim 11, wherein the accessing module is further configured to:
access item preferences of the user; and
determining a subset of the item descriptors based on the item preferences of the user, and wherein the generating module is further configured to generate the search query based on the determined subset of the item descriptors.

13. The system of claim 11, wherein the abstraction of the items describes at least one of items belonging to a category, items used in a specific context, items sharing an attribute, items used in a specific situation, and items that serve a specific purpose.

14. The system of claim 11, wherein the generating module is further configured to add the item descriptors to the search query, and wherein the presenting module is further configured to present the item descriptors added to the search query.

15. The system of claim 11, wherein the receiving module is further configured to receive the indication from the device operated by the user to perform the search, and wherein the system further comprises a search module configured to perform the search based on the search query generated based on the item descriptors accessed from the database.

16. The system of claim 11, wherein the receiving module is further configured to receive an identification of a second user, wherein the accessing module is further configured to:
access item preferences of the second user based on the received identification of the second user; and
determine a further subset of the item descriptors based on the item preferences of the second user, and wherein the generating module is further configured to generate the search query based on the further subset of the item descriptors.

17. The system of claim 11, wherein the receiving module is further configured to receive an indication of a further item as being included in the abstraction of the items prior to receiving the input that describes the abstraction of the items from the first user, and wherein the accessing module is further configured to access item descriptors of the further item based on receiving the indication of the further item as being included in the abstraction of the items.

18. The system of claim 17, wherein the receiving module is further configured to receive an identification of a second user, wherein the accessing module is further configured to:
access item preferences of the second user based on the received identification of the second user; and wherein the system further comprises a comparing module configured: to measure an amount of overlap between the item preferences of the second user; and determine the amount of overlap between the item preferences of the first user and the second user as exceeding a predetermined threshold amount, and wherein the indication of a further item as being included in the abstraction of the items is received from the second user.

19. The system of claim 11, wherein the item descriptors are absent from the abstraction of the items.

20. A non-transitory machine-readable medium storing instructions which, when executed by one or more processors, cause the machine one or more processors to perform operations comprising:
receiving an input describing an abstraction of items, the input received from a device operated by a user;
accessing item descriptors from a database based on the abstraction of the items described in the input received from the device operated by the user, the item descriptors being of the items included in the abstraction of the items;
generating a search query based on the item descriptors accessed from the database; and
presenting the generated search query to the device operated by the user, the presenting done prior to receiving an indication from the device operated by the user to perform a search.
